(19) United States
(12) Patent Application Publication
(10) Pub. No.: US 2014/0197099 A1
(43) Pub. Date: Jul. 17, 2014

(54) Wastewater Treatment Bed, Facility and Method

(71) Applicant: OHIO STATE INNOVATION FOUNDATION, COLUMBUS, OH (US)

(72) Inventors: Karen Mancl, Columbus, OH (US); Ryan Kopp, Greendale, IN (US); Rashmi S. Gaur, Powell, OH (US); Olli H. Tuovinen, Columbus, OH (US)

(21) Appl. No.: 14/151,856

(22) Filed: Jan. 10, 2014

Related U.S. Application Data
(60) Provisional application No. 61/751,535, filed on Jan. 11, 2013.

(51) Int. Cl. C02F 3/04; C02F 3/10

(52) U.S. Cl. CPC C02F 3/04; C02F 3/104; C02F 3/103
USPC 210/617; 210/291; 210/290; 210/257.1; 210/253; 210/170.04

(57) ABSTRACT

A facility and a method for treating high strength wastewater include a plurality of beds having layers of granular and textile material through which the wastewater flows for reduction of BOD and COD. The wastewater is conducted to and from the beds using piping networks. Distribution conduits and drain conduits are arranged within the bed. Wastewater flow is controlled by valves remotely actuated via a control system.

### CROSS REFERENCE TO RELATED APPLICATIONS

This application is based upon and claims priority to U.S. Provisional Application No. 61/751,535 filed Jan. 11, 2013, which is hereby incorporated by reference.

### FIELD OF THE INVENTION

This invention relates to treatment beds, facilities, and methods for treating wastewater, and especially high strength wastewater.

### BACKGROUND

High strength wastewater, i.e., wastewater with a biochemical oxygen demand (BOD) of at least 300 mg O₂/l or greater, as well as wastewater with a chemical oxygen demand (COD) of at least 500 mg O₂/l, presents various treatment challenges. Such wastewater is produced, for example, by food processing plants, dairy farms and restaurants. Wastewater from the processing of meat and poultry are particularly challenging due to their characteristic elevated levels of fat and various colloidal and suspended solids resulting from the slaughtering and carcass rinsing processes. Turkey processing wastewater contains dissolved organics, suspended solids in the form of proteins, blood residue, grease and fats along with cleaning and sanitizing agents.

Although such wastewater can be effectively treated using sand bioreactors wherein a “biofilm” of microorganisms forms on the sand particles, the high strength wastewater tends to clog such filters at a rate which renders them impractical for large scale use. Primary causative agents of clogging are believed to include BOD loading rates, suspended solids and bacteria.

The clogging problem has been addressed using layered granular filter media of varying coarseness. In one example, layers of pea gravel and coarse sand were used as a pre-filter atop a fine sand bioreactor. While layered sand and gravel filter media have been shown effective at preventing or reducing the rate of clogging, such filters come with certain disadvantages, cost being at the forefront. Various suitable grades of sand and gravel are not naturally available, they must be prepared (i.e., screened, washed) and then transported in bulk to the site of the treatment facility. As can be appreciated, for large scale operations the filter media cost alone may be prohibitive. There is clearly a need for a treatment bed which can effectively treat high strength wastewater

### SUMMARY

The invention concerns a method of treating high strength wastewater. In one example embodiment, the method comprises:
flowing wastewater having a biochemical oxygen demand of at least 300 mg O₂/l through a first layer comprising a plurality of textile leaves, the leaves being arranged one atop another;
flowing the wastewater from the first layer through a second layer comprising a granular material.

By way of example, the textile leaves are arranged randomly atop one another. The textile leaves may have a rectangular shape. The first layer may be between about 10 cm thick and about 60 cm thick. In a particular example embodiment, the first layer is about 30 cm thick. The textile leaves may comprise a woven material or a non-woven material. In a specific example the textile leaves comprise felt. The felt may be selected from the group consisting of polyester, polypropylene, nylon and combinations thereof.

The granular material may comprise sand. The sand may have an effective size from about 0.25 mm to about 1.0 mm and a uniformity coefficient between about 1.0 and about 4.0. In a particular example embodiment, the sand has an effective size of about 0.3 mm and a uniformity coefficient of about 4.0.

The invention also encompasses a bed for treating wastewater. In one example embodiment, the bed comprises a layer of first granular material. A layer of treatment material is positioned above the layer of first granular material. At least one distribution conduit is positioned above the layer of treatment material for discharging the waste water onto the layer of treatment material At least one drain conduit positioned beneath the layer of first granular material. The at least one drain conduit collects the wastewater and conducts it away from the layers. A water impermeable layer is positioned beneath the at least one drain conduit. In one example embodiment the first granular material comprises fine sand. The treatment material may comprise pea gravel. In another example embodiment, the treatment material comprises a plurality to textile leaves. The textile leaves may be arranged randomly atop one another. The textile leaves may have a rectangular shape. The textile leaves may comprise a woven material or a non-woven material. In a specific example embodiment, the textile leaves comprise felt. The felt may be selected from the group consisting of polyester, polypropylene, nylon and combinations thereof.

By way of example, the water impermeable layer may comprise a waterproof liner. A layer of sand may be positioned beneath the waterproof liner.

The example embodiment may further comprise a layer of second granular material positioned between the layer of first granular material and the at least one drain conduit. In a particular example, the layer of second granular material comprises wash rock. The example embodiment may further comprise a layer of third granular material positioned between the layer of second granular material and the layer of first granular material. In a particular example embodiment, the layer of third granular material comprises pea gravel.

By way of example, the invention may further comprise at least one branch conduit positioned between the layer of first granular material and the distribution conduit. In this example, at least one riser conduit extends between and provides fluid communication between the at least one branch conduit and the at least one distribution conduit. This example may further comprise a supply header positioned between the layer of first granular material and the at least one distribution conduit. The supply header is in fluid communication with a source of the wastewater. The at least one branch conduit is in fluid communication with the supply header in this example.

In another example embodiment, the invention further comprises a valve positioned between the riser conduit and the at least one distribution conduit for controlling flow of the wastewater therethrough. The valve may be a solenoid valve. The example embodiment may further comprise an indexing valve positioned between the riser conduit and the at least one distribution conduit.

In another example embodiment, a layer of fourth granular material is positioned between the treatment layer and the layer of first granular material. In a specific example embodiment, the layer of fourth granular material comprises coarse sand. A fifth granular material may be positioned above the layer of treatment material by way of example. In a specific example, the fifth granular material comprises pea gravel.

In another example embodiment of a bed for treating wastewater, the bed comprises a drain header and a plurality of drain conduits in fluid communication with the drain header. A supply header is positioned above the drain header and a plurality of branch conduits are in fluid communication with the supply header. The branch conduits are positioned above the drain header. A plurality of riser conduits are included, each one of the riser conduits extending from a respective one of the branch conduits. A plurality of manifolds are positioned above the branch lines, each one of the manifolds being in fluid communication with a respective one of the riser conduits. A plurality of distribution conduits are positioned above the branch lines. At least two of the distribution conduits are in fluid communication with each of the manifolds. The distribution conduits discharge the wastewater therefrom. A layer of first granular material is positioned between the drain conduits and the distribution conduits and a layer of treatment material is positioned between the layer of first granular material and the distribution conduits.

Another example embodiment further comprises a plurality of valves. Each of the valves is positioned between one of the riser conduits and one of the manifolds for controlling flow of the wastewater between the riser conduits and the manifolds. The valves may be remotely controllable valves. In a specific example embodiment the valves are solenoid valves. The example embodiment may further comprise a plurality of indexing valves. Each of the indexing valves is positioned between one of the valves and one of the manifolds for directing flow of the wastewater into the manifolds.

By way of example, the first granular material may comprise fine sand. The treatment material may comprise pea gravel. In another example embodiment, the treatment material comprises a plurality of textile leaves. The textile leaves may be arranged randomly atop one another. The textile leaves may have a rectangular shape. The textile leaves may comprise a woven material or a non-woven material. In a particular example embodiment, the textile leaves comprise felt. The felt may be selected from the group consisting of polyester, polypropylene, nylon and combinations thereof.

In a further example embodiment, a waterproof liner is positioned beneath the drain conduits. A layer of sand may be positioned beneath the waterproof liner.

Another example embodiment comprises a layer of second granular material positioned between the layer of first granular material and the drain conduits. The layer of second granular material may comprise wash rock. By way of further example, an embodiment may comprise a layer of third granular material positioned between the layer of second granular material and the layer of first granular material. In a specific embodiment, the layer of third granular material comprises pea gravel. Another example embodiment may further comprise a layer of fourth granular material positioned between the treatment layer and the layer of first granular material. In a specific example embodiment, the layer of fourth granular material comprises coarse sand. Another example embodiment comprises a fifth granular material positioned between the manifolds and the layer of treatment material. The fifth granular material comprises pea gravel in a specific example embodiment.

In an example embodiment, the distribution conduits have a plurality of holes therein for discharge of the wastewater. The holes may be spaced apart from one another at intervals of about 1 foot. Furthermore, in this example embodiment, the drain conduits may have a plurality of slots therein, the slots for admitting wastewater to the drain conduits for removal from the bed.

By way of example, the invention may further comprise a storage tank for holding the wastewater. This example embodiment may also comprise a pump in fluid communication with the storage tank and the supply header for pumping the wastewater from the tank to the supply header. In a further example embodiment, a pump is in fluid communication with the drain header, the pump for pumping the wastewater from the drain header and out of the bed.

In one example embodiment of the invention, the bed is located within an excavation site.

The invention further encompasses a facility for wastewater treatment comprising a plurality of beds. In example embodiments, the facility may further comprise a storage tank for holding the wastewater and a first piping network providing fluid communication between the storage tank and the supply header of each of the beds. A second piping network may be used to provide fluid communication between the drain headers of each of the beds.

In another example embodiment, the invention may further comprise a first pump positioned between the storage tank and the first piping network for pumping the wastewater from the storage tank into the supply headers of each of the beds. A second pump may be in fluid communication with the second piping network for pumping the wastewater from the drain headers of each of the beds.

The invention further encompasses a method of operating the facility. In one example embodiment, the method comprises:
flowing a predetermined amount of the wastewater to only a first one of the beds;
stop flowing the wastewater to the first one of the beds;
flowing a predetermined amount of the wastewater to only a second one of the beds;
stop flowing a predetermined amount of the waste water to the second one of the beds.

The method of operating the facility may further comprise, by way of example, flowing a predetermined amount of the wastewater to each one of the beds in turn, one after another, for all of the plurality of beds.

### BRIEF DESCRIPTION OF THE DRAWINGS

FIG. 1 is a schematic diagram of a wastewater treatment facility according to the invention;

FIGS. 2 and 3 are schematic diagrams of portions of the wastewater treatment facility shown in FIG. 1;

FIG. 4 shows a cross sectional view of a portion of the facility shown in FIG. 1;

FIG. 5 is a schematic diagram of a portion of the wastewater treatment facility shown in FIG. 1;

FIGS. 6 and 7 are schematic diagrams depicting laboratory test apparatus for testing layered media arrangements of water treatment beds.

### DETAILED DESCRIPTION

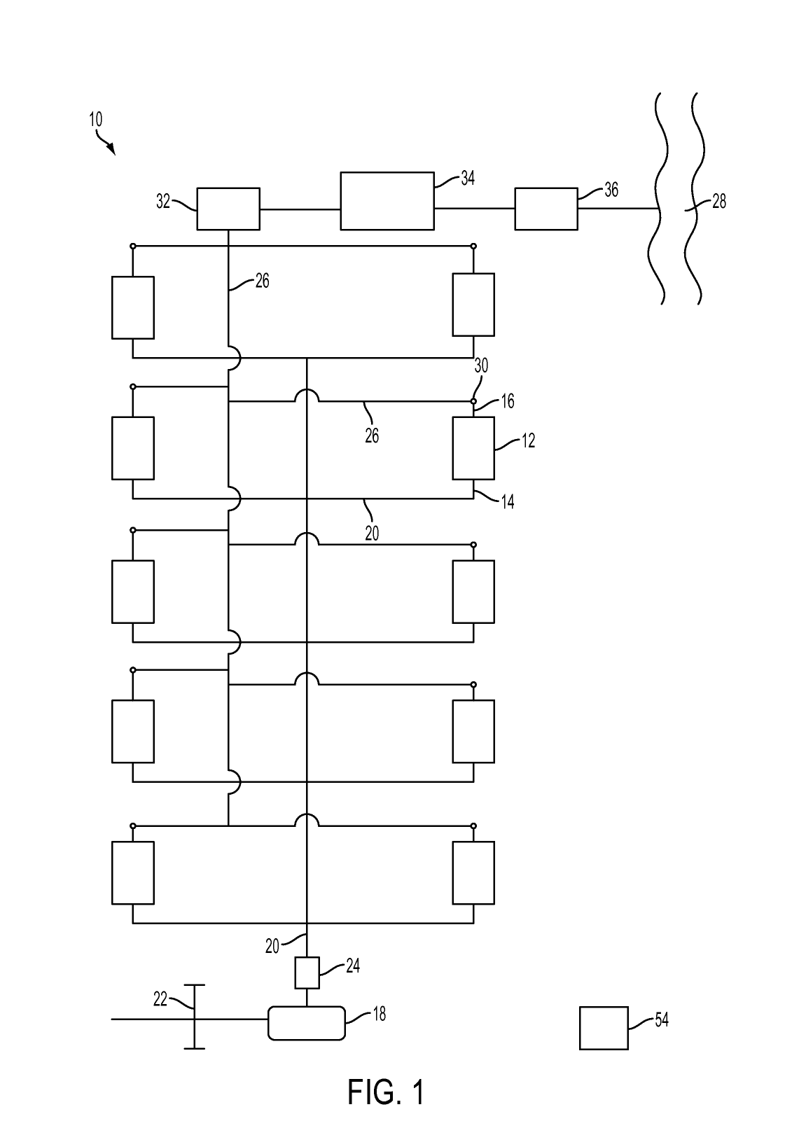

FIG. 1 illustrates a facility 10 for wastewater treatment, the facility comprising a plurality of treatment beds 12. Each bed 12 comprises a supply header 14 which conducts wastewater influent to the bed 12 for treatment, and a drain header 16 which conducts treated wastewater effluent away from the bed. The supply headers 14 are in fluid communication with a storage tank 18 via a first piping network 20. Storage tank 18 stores wastewater influent to be treated in the facility 10. Before being admitted to tank 18 the wastewater influent is screened and solids are removed in a screening device 22. A pump 24 is positioned between the tank 18 and the first piping network 20 for pumping the wastewater influent from the tank to the supply headers 14 of each of the beds 12.

Drain headers 16 in each of the beds 12 are in fluid communication with a second piping network 26. After treatment in each bed 12, wastewater effluent is collected from the drain headers 16 and conducted through the second piping network 26 for eventual discharge to the local watershed 28, in this example, a nearby river. Additional devices may be interposed between the beds 12 and the watershed. In this example facility 10, each bed 12 also includes a sump compartment 30 in fluid communication with the drain header 16 and the second piping network 26. Each sump compartment provides access to the wastewater effluent from its respective bed 12, allowing effluent samples to be taken to evaluate the treatment performance of each bed. A second pump 32 may also be employed to pump effluent to an effluent treatment station 34 where the total effluent from the facility 10 may be analyzed for water quality as well as receive additional treatment such as ultraviolet sterilization and/or nutrient removal before discharge. A third pump 36 may be used to pump the effluent from the station 34 for ultimate discharge.

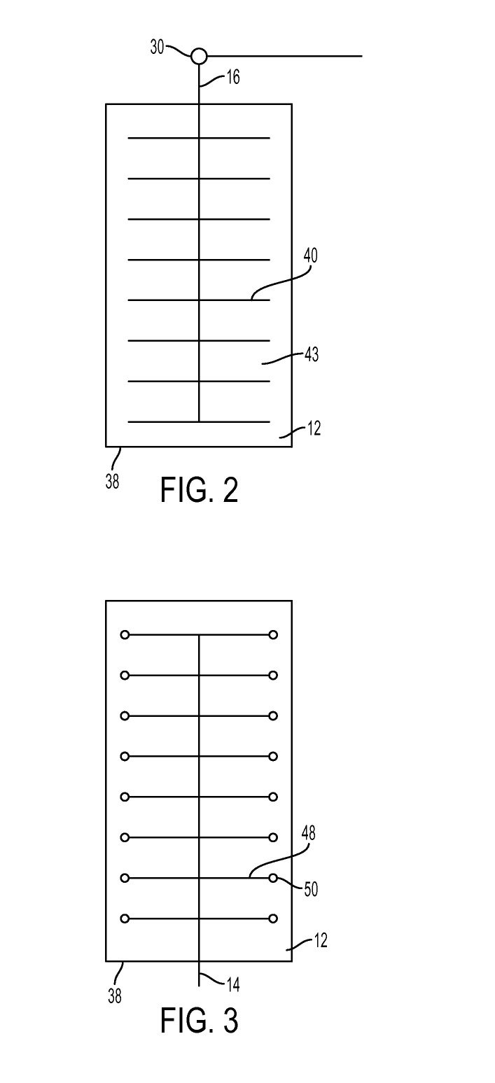

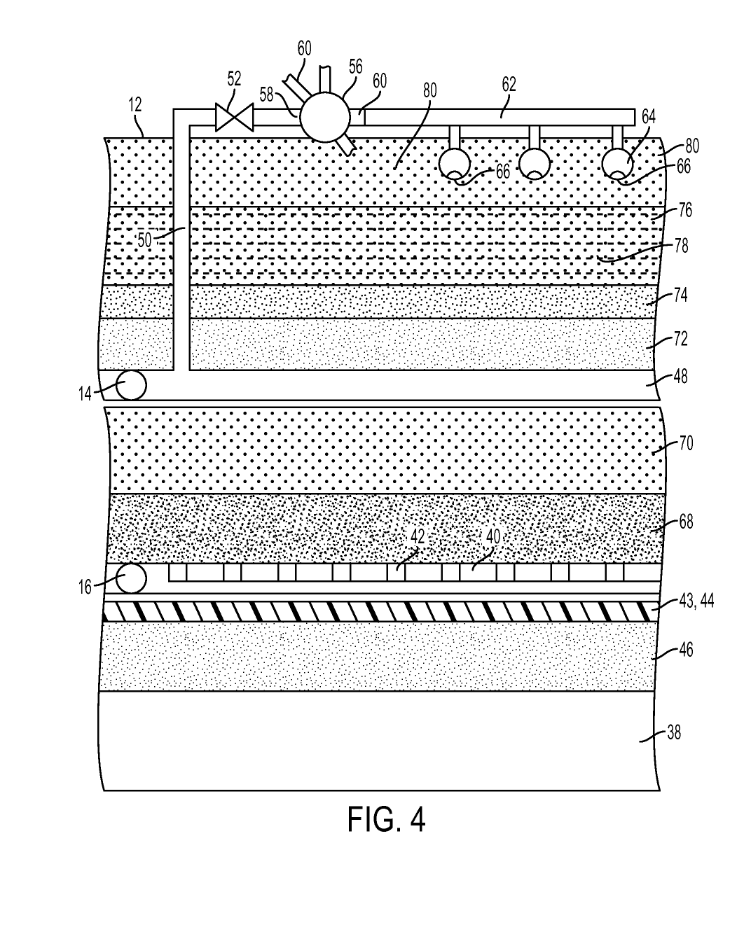

FIG. 2 illustrates one of the beds 12, which in this example facility 10 comprises an excavation site 38 positioned in a field. An actual excavation site 38 may measure, for example, 82 feet by 180 feet, the total facility having twelve such excavation sites and covering about 4 acres of land. FIG. 2 illustrates the lowermost of the conduits comprising the bed 12, and shows the drain header 16 in fluid communication with a plurality of drain conduits 40. The drain conduits 40 are distributed throughout the excavation site 38 and conduct wastewater effluent from across the site to the drain header for removal from the bed 12 through the second piping network 26 (see FIG. 1). To effect effluent drainage from the site the drain conduits 40 have a plurality of transverse slots 42 as shown in FIG. 4. This permits the effluent to enter the drain conduits through gravity and be conducted to the drain header 16. It is advantageous to position a water impermeable layer 43 beneath the drain conduits 40 to ensure that the effluent is channeled into the drain header and not allowed to pass into the subsoil beneath and surrounding the excavation site 38. The water impermeable layer 43 may be formed for example, by a layer of clay, or a synthetic waterproof liner 44 of PVC or other waterproof plastic. A layer of leveling sand 46 is positioned beneath the liner to support it and prevent tears when under pressure from the wastewater and other layers comprising the bed 12.

FIG. 3 again illustrates the bed 12 and shows the supply header 14 which is positioned above the drain header 16 (not shown in FIG. 3 for clarity). As described above and shown in FIG. 1, the supply header 14 is in fluid communication with the source of wastewater influent, storage tank 18, through the first piping network 20. Referring again to FIG. 3, a plurality of branch conduits 48 are in fluid communication with the supply header. Branch conduits 48 are distributed over the excavation site 38 and extend outwardly from the supply header. Each branch conduit 48 is in fluid communication with at least one riser conduit 50. In the example configuration shown in FIG. 4, the riser conduits 50 extend vertically from each branch conduit 48. A respective valve 52 is in fluid communication with each riser conduit for controlling the flow in wastewater influent from the storage tank 18. It is advantageous that valves 52 be remotely controllable, such as, for example, solenoid valves, which can be opened and closed individually via an electrically based control system 54 as shown in FIG. 1. Example commercially available solenoid valves suitable for use in this facility are marketed by KRain of Riviera Beach, Fla. Control system 54 may be, for example, a programmable logic controller or a computer with resident software which controls the opening and closing of the various valves 52 according to an algorithm (examples of which are described below). Communication between the control system 54 and the valves 52 (as well as the various pumps 24 and 36, which the control system may also control) may be via dedicated wires (not shown) or wirelessly via radio signals. An example of a commercially available control system is provided by Horner APG of Indianapolis, Ind.

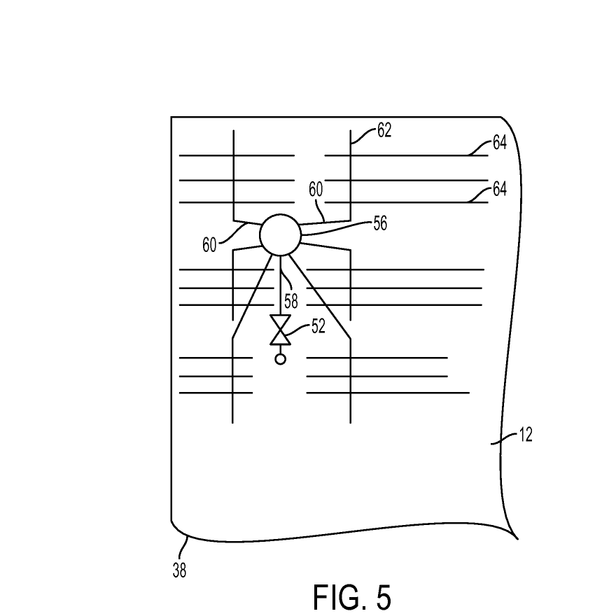

As shown in FIGS. 4 and 5, each valve 52 is also in fluid communication with a respective indexing valve 56. Indexing valves 56 are also advantageously remotely controlled. Example indexing valves suitable for use in this facility are commercially available from Fimco Industries of Big Sioux, S. Dak. Each indexing valve 56 has an inlet 58 (in fluid communication with a respective valve 52) and a plurality of outlets 60. The indexing valve 56 can selectively place one of the plurality of outlets 60 in fluid communication with its respective valve 52, which, when open, will allow wastewater influent to flow to the selected outlet 60. Each outlet 60 on each indexing valve 56 is in fluid communication with a respective one of a plurality of manifolds 62. Each manifold 62 is in fluid communication with a plurality of distribution conduits 64. As shown in FIG. 5, the distribution conduits 64 are spaced throughout the bed 12. In this example, the spacing between distribution conduits is about 1 foot between centers over the entire bed 12. As shown in FIG. 4, each distribution conduit 64 has a plurality of holes 66 therein for discharging the wastewater influent from the distribution conduits into the bed 12. Spacing between holes 66 in this example was also approximately on 1 foot centers such that between the spacing of the distribution conduits 64 and the holes 66 each square foot of bed 12 receives wastewater influent from a respective hole 66.

As shown in FIG. 4, bed 12 comprises a plurality of layers. Described from bottom to top, the layers in this example bed include the leveling sand layer 46 (fine sand, approximately 2 inches thick) which supports the water impermeable layer 43, i.e. liner 44, having a thickness of about 30 mil. The drain header 16 and its associated drain conduits 40 sit atop the water impermeable layer 42. Liner 44, the drain header 16 and the drain conduits 40 are covered with about 6 to 8 inches of “wash rock” 68 having a size range of about ¾inch to about 1 inch. A layer 70 of pea gravel from about 2 inches to about 3 inches thick sits on the wash rock layer 68. The pea gravel comprising layer 70 range in size from about ¼inch to about ½ inch. The pea gravel layer 70 and the wash rock layer 68 cooperate to prevent finer granular material from the layers above from being washed out of the bed 12 through the drain conduits 40.

The supply header 14 and its associated branch conduits 48 are supported on the pea gravel layer 70 along with a layer 72 of fine sand of about 18 inches thick. The sand of the fine sand layer 72 ranges in size from about 0.3 mm to about 1.18 mm. A layer 74 of coarse sand of from about 4 inches to about 6 inches thick sits above the fine sand layer 72, the coarse sand of layer 74 have a size ranging between about 1.18 mm to about 4.75 mm.

A layer 76 of treatment material is positioned between the coarse sand layer 74 and the distribution conduits 64. In one example bed 12, the treatment material layer 76 comprises a layer of pea gravel of about 6 inches thick, the pea gravel ranging in size from about ¼inch to about ½ inch. In another example embodiment, the treatment layer 76 comprises a plurality of textile leaves 78. Textile leaves 78 may have a polygonal shape, for example, rectangular, and dimensions of about 2 inches by 4 inches and about ⅛ inch to about ¼ inches thick. Other shapes and sizes are also feasible, and it is believed that textile leaves from about one half to double the size noted above will be effective. The textile leaves 78 may be formed of a woven material, but are advantageously formed of non-woven material such as felt. The felt may comprise synthetic fibers such as polyester, polypropylene, nylon and combinations thereof. While natural fibers such as cotton and wool are also feasible, the synthetic fibers are advantageous because they do not decompose like the natural fibers. When the treatment layer 76 is formed of textile leaves 78, it, and the distribution conduits 64 may be covered by a finishing layer 80 of pea gravel. The valves 52 and indexing valves 56 remain exposed for ease of servicing along with the manifolds 62.

A particular example experimental test facility 10 was constructed. The facility 10 occupied a 4 acre site which included twelve beds 12, each bed measuring 82 feet by 180 feet. The storage tank 18 had a working volume of 80,000 gallons and the pump 24 had a flow rate of 200 gallons per minute. The pump 24 supplied wastewater influent to the beds at a pressure of about 44 psig. Each bed had twenty remotely controlled valves 52 (KRain 150 Series Solenoid Valve) which controlled the flow of wastewater influent to twenty remotely controlled indexing valves 56 (Fimco 6 Outlet Indexing Valve). Each valve 52 had a maximum flow rate of 50 gallons per minute. Each indexing valve 56 had six outlets 60, and each outlet fed a respective manifold 62. Each manifold 62 was in fluid communication with six distribution conduits 64 for a total of 720 distribution conduits per bed and 8,640 total among the twelve beds 12.

The first piping network 20 which supplies wastewater influent to the beds 12 comprised PVC pipe having a diameter of 4 inches. The second piping network 26 which conducts the wastewater effluent from the beds 12 after treatment comprised PVC pipe having a diameter of 8 inches. The second pump 32 had a capacity of 200 gallons per minute and operated at 14 psig. The discharge pump 36 had a capacity of 200 gallons per minute and operated at 34 psig. Drain conduits 40 comprised PVC pipe having a diameter of 4 inches and slots of ¼inches in width spaced on 6 inch centers. Riser conduits 50 comprised PVC pipe having a diameter of 1½ inches. Manifolds 62 comprised PVC pipe having a diameter of 1½ inches, and distribution conduits 64 comprised PVC pipe having a diameter of 1 inch with discharge holes 66 separated on one foot centers as noted.

In experimental test facility 10, each bed comprised a layer of fine leveling sand 46 2 inches thick, a 30 mil PVC water impermeable liner 44, a 6 inch thick layer of wash rock 68, a two inch layer of pea gravel 70, an 18 inch thick fine sand layer 72, a six inch coarse sand layer 74, a six inch thick treatment layer 76 of pea gravel and a finishing layer 80, also of pea gravel.

In operation of experimental test facility 10, valves 52 are opened in groups of four at a time in a first bed 12 for a dose duration of 50 seconds. After all valves 52 in the first bed 12 have been opened once in turn, the cycle starts again, but the indexing valve 56 is actuated, resulting in the wastewater influent being directed to a different manifold 62 and thus to different distribution conduits 64. This cycle is repeated six times for the first bed (there being six manifolds per valve) such that all of the distribution conduits 64 have dosed the first bed 12 for 50 seconds. This same flow regime is then repeated for each bed 12 in turn. The facility 10 with its twelve beds 12 is capable of 3 full doses per bed per day of operation.

As shown in FIG. 1, wastewater flow though the experimental test facility 10 proceeded with the wastewater influent being screened at device 22 for removal of solids. Solids as small as 0.020 inches are effectively removed. The influent is then stored in tank 18, from which it is pumped by pump 24 through first piping network 20. Piping network 20 supplies the influent to supply headers 14 in each bed 12 (see FIG. 3). The influent is distributed through branch conduits 48 to riser conduits 50. As shown in FIG. 4, valves 52 and 56 control the flow of influent to the manifolds 62, which, in turn, direct the influent to groups of distribution conduits 64. Influent is discharged to the bed 12 through holes 66 in the distribution conduits 64 where it passes through the treatment layer 76, the coarse sand layer 74, the fine sand layer 72, the pea gravel layer 70, the wash rock layer 48, stopping at the water impermeable layer 43 (liner 44). Most of the processing of the influent occurs as it passes through the fine sand layer 72 where the bulk of the biodegradation occurs, the fine sand layer providing a medium for microbial biofilm which removes the BOD and COD from the influent.

The wastewater, now “effluent” passes through slots 42 and is collected in the drain conduits 40 shown in FIG. 2. Drain conduits 40 conduct the effluent to drain header 16 which leads to sump compartment 30. Effluent samples from a particular bed 12 may be collected at the sump compartment to evaluate the bed performance. The effluent from each of the beds 12 drains from the sump compartments 30 to the second piping network 26 from which it is pumped via pump 32 to the effluent treatment station 34. The effluent may be analyzed and/or further treated at the station, for example sterilized with ultraviolet light or subject to nutrient removal. The effluent is then pumped and discharged to the watershed 28 via pump 36.

Operation of the system as described above has shown that the system performance exceeds limits of BOD<10, TSS<12 (Total Suspended Solids), Ammonia<1 Summer, Ammonia<3 Winter.

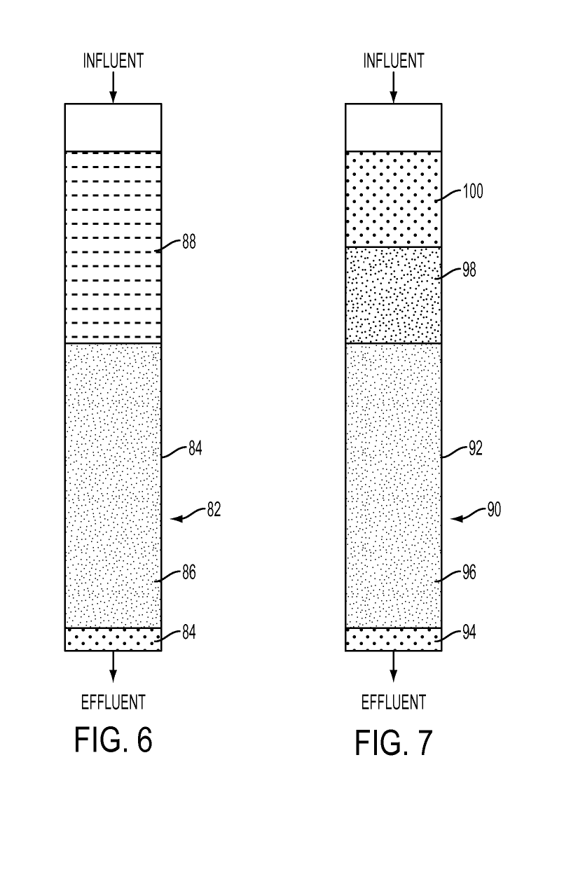

Use of the treatment material layer 76 of pea gravel in the experimental test facility 10 has proven effective at mitigating clogging of the beds 12 when processing high strength wastewater (wastewater having a BOD greater than 300). However, based upon comparative laboratory tests it is also expected that textile leaves 78 may be substituted for the pea gravel in the treatment material layer 76 of beds 12. As shown in FIG. 6, a bioreactor column 82 was constructed within a transparent plastic tube 84, the tube having a diameter of 14.5 cm and a length of 80 cm. The bioreactor column 82 comprised, from bottom to top, a 5 cm layer 84 of pea gravel to facilitate drainage from the column, a 45 cm layer 86 of fine sand and a 30 inch layer 88 of textile leaves. The fine sand had an effective size of 0.3 mm and a uniformity coefficient of 4.0. The pea gravel had an effective size of 3.8 mm and a uniformity coefficient of 1.7. (Size and uniformity coefficient measurements herein made according to ASTM. 2003. C117-95: Standard test method for materials finer than 75 μm (no. 200) sieve in mineral aggregates by washing. American Society for Testing and Materials, West Conshohocken, Pa., hereby incorporated by reference herein). The textile leaves were rectangular in shape, measured 2 inches by 3 inches and ¼ inches thick. The textile leaves were a felt comprised of polyester and commercially available from Wastewater Innovations Inc. of Batesville Ind. It is thought that the textile leaves could range in size from double the stated dimensions to half thereof, and still be effective.

In the test, the performance of the sand/textile leaf bioreactor column 82 was compared with that of a sand/gravel bioreactor column 90, shown in FIG. 7. Bioreactor column 90 was also constructed within a transparent plastic tube 92, the tube having a diameter of 14.5 cm and a length of 80 cm. The bioreactor column 90 comprised, from bottom to top, a 5 cm layer 94 of pea gravel to facilitate drainage from the column, a 45 cm layer 96 of fine sand, a 15 cm layer 98 of coarse sand and a 15 cm layer 100 of pea gravel. The fine sand had an effective size of 0.3 mm and a uniformity coefficient of 4.0 (ASTM 2003). The pea gravel had an effective size of 3.8 mm and a uniformity coefficient of 1.7 (ASTM 2003). The coarse sand had an effective size of 2.4 mm and a uniformity coefficient of 1.3 (ASTM 2003).

In the test, pairs of each column type 82 and 90 were operated under the same conditions and parameters as described in Table 1, the only difference being a slightly smaller surface area available for biofilm formation for bioreactor columns 82 having the textile leaf layer 88. This testing regime permitted a head to head comparison between sand/gravel columns 90 and columns 82 using the textile leaf layer.

TABLE 1
Specifications of the sand/gravel and sand/textile bioreactors.

| Parameter | Sand/gravel | | Sand/textile | |
|---|---|---|---|---|
| Filter diameter | 14.5 | cm | 14.5 | cm |
| Filter length | 80 | cm | 80 | cm |
| Filter volume | 13.41 | | 13.41 | |
| Top surface area | 0.016 | m² | 0.016 | m² |
| Dosing frequency | 72 | times/day | 72 | times/day |
| Dosing time | 2 | min/dose | 2 | min/dose |
| Daily input | 1.09 | l/day | 1.09 | l/day |
| Hydraulic loading | 66 | l/m²/day | 66 | l/m²/day |
| Hydraulic loading | 1.63 | gal/ft²/day | 1.63 | gal/ft²/day |
| Total available surface area for | 161 | m² | 151 | m² |
| biofilm formation | | | | |

The operation and performance of the bioreactors 82 and 90 are described in detail below for treatment of turkey processing wastewater.

Grab samples of turkey processing wastewater were retrieved from a discharge pipe following a grease trap located in a storage pond at Whitewater Processing Inc., Harrison, Ohio. Samples were taken during the day shift at random dates and times every 3 to 4 weeks and stored in the laboratory at 4° C. until used in the experiments. The composition of wastewater varied with the production activities in the turkey processing facility. The wastewater was applied on bioreactor columns 82 and 90 using a programmable, time controlled pump at the hydraulic loading rate of 66 L/m²/day (1.63 gal/ft²/day) in 72 timed daily doses. The columns 82 and 90 were operated indoors at 22±2° C. Wastewater influent and effluent samples were analyzed once a month for BOD₅ and COD using the standard methods (APHA. 1998. Standard Methods for the Examination of Water and Wastewater. 20th ed. American Public Health Association, Washington, D.C., hereby incorporated by reference herein).

The clogging of columns 82 and 90 was estimated with the procedure described by Xi and others (Xi, J., K. M. Mancl and O. H. Tuovinen. 2005. Carbon Transformation During Sand Filtration of Cheese Processing Wastewater. Applied Engineering in Agriculture. 2(2): 271-274, hereby incorporated by reference herein). The volume of the daily dose was applied in one single dose to the columns 82 and 90. The clogging index (CI) was calculated as the ratio of the effluent volume collected in the first 90 min over the daily dosing volume applied to the columns following a rest period of 24 h.

The associations between the BOD₅ and COD removal efficiencies, different media types and bioreactor run times over the entire experimental period were analyzed using one-way ANOVA with a 95% confidence interval using Minitab 15 Statistical Software.

The turkey processing wastewater was treated with the sand/gravel bioreactors 90 and sand/textile bioreactors 82 at a loading rate of 66 L/m²/day (1.63 gal/ft²/day). The influent BOD₅ ranged from 460 to 2260 mg O₂/l and the COD values ranged from 840 to 2260 mg O₂/l (Table 2). The effluent from both the sand/gravel and the sand/textile bioreactor columns 90 and 82 had BOD₅ values of 10 mg/l or less, with just one exception. COD effluent values ranged from 4 to 70 mg O₂/l. The efficiencies of BOD₅ and COD removal remained constant throughout the period of study. The corresponding BOD₅ and COD removal efficiencies were >99% and >95%, respectively, even after over 26 months of column operation. Thus all of the bioreactors demonstrated steady, uninterrupted treatment efficiency.

The BOD₅ and COD results obtained for sand/gravel bioreactor 90 and sand/textile bioreactor 82 were analyzed using ANOVA. The differences in BOD₅ and COD removal between the two different treatment matrices were statistically not significant (P>0.05).

TABLE 2
Influent and effluent BOD₅ and COD values in
sand/gravel and sand/textile bioreactors.

| | BOD₅ (mg/L) | | | COD (mg/L) | | |
|---|---|---|---|---|---|---|
| | | Effluent | | | Effluent | |
| Time | | Sand/ | Sand/ | | Sand/ | |
| (Days) | Influent | gravel | textile | Influent | gravel | Sand/textile |
| 58 | 570 | 2 | 2 | 1350 | 25 | 55 |
| 94 | 460 | 1 | 1 | 1010 | 31 | 29 |
| 121 | 540 | 10 | 8 | 1210 | 52 | 63 |
| 155 | 460 | 3 | 2 | 1500 | 4 | 27 |
| 185 | 1250 | 2 | 2 | 2360 | 14 | 21 |
| 214 | 990 | 3 | 1 | 1310 | 28 | 12 |
| 240 | 830 | 3 | 1 | 1270 | 24 | 48 |
| 270 | 1220 | 1 | 2 | 1800 | 4 | 24 |
| 319 | 810 | 7 | 5 | 1580 | 12 | 43 |
| 347 | 480 | 2 | 2 | 1720 | 28 | 37 |
| 387 | 870 | 20 | <0.5 | 1380 | 70 | 60 |
| 417 | 1220 | 8 | 3 | 1950 | 23 | 8 |
| 487 | 1790 | 2 | 1 | 2710 | 19 | 16 |
| 563 | 1650 | 2 | 1 | 2760 | 7 | 7 |
| 618 | 540 | 4 | 2 | 1170 | 16 | 16 |
| 695 | 550 | 4 | 1 | 840 | 12 | 24 |
| 784 | 2260 | <0.5 | <0.5 | 3920 | 48 | 20 |

Clogging was not a problem in these experiments. The pea gravel layer 100 and textile leaf layer 88 each acted as a sieve to trap suspended solids and fat globules. Therefore, the typical approaches of effluent recycling and separation of solids from the turkey processing wastewater were not needed allowing for extended filter operation without clogging. Biofilm communities on the surface of pea gravel in layer 100 and textile leaves in layer 88 can act upon trapped organic matter but the major biodegradation activity is associated with the biofilm in the sand layers 86, 96 and 98. Previous work has demonstrated that the pea gravel layer 100 extends the useful life of bioreactor operation as compared to bioreactors without pea gravel. By placing the coarse sand/pea gravel layers 98 and 100 or textile leaf layer 88 on top, no additional land area is required for a pretreatment module as these layers overlaid the final treatment unit of fine sand.

After 15 months of column operation, clogging was measured using the aforementioned procedure developed by Xi and others. For no clogging, the clogging index (CI) is 1.0, and complete clogging has a CI of 0.0. Test results showed that the sand/gravel bioreactor columns 90 had CI values of 0.64 and 0.69. The CI values for the sand/textile bioreactor columns 82 were slightly more clogged at 0.53 and 0.60. In spite of the slight difference in the amount of clogging in sand/gravel and sand/textile bioreactors, the BOD₅ and COD removal efficiencies were comparable.

Clogging test were repeated after 19 months of column operation. The CI values were 0.66 and 0.67 for sand/gravel columns 90 and 0.61 and 0.65 for the sand/textile columns 82. No significant differences in the CI values were discerned between the sand/gravel and sand/textile columns (Table 3).

The clogging tests were performed to assess the condition and treatment capability of the bioreactors. A CI value of 1 indicates no clogging. The clogging test results obtained showed a reasonable amount of clogging (˜35%) for all the bioreactors. Wastewater treatment efficiency showed no change as the removal of >99% BOD₅ and >95% COD was sustained for all columns for the entire course. The results suggest that partial clogging did not have a negative effect on the treatment of wastewater. In fact, it is possible that partial clogging may enhance the treatment by increasing the contact time of waste with the biofilm.

TABLE 3
Clogging index values where 1 indicates no clogging and 0 indicates
complete clogging.

Clogging
Index (C.I.)

| Type of Bioreactor | 15 months | 19 months |
|---|---|---|
| Sand/gravel (SB1) | 0.69 | 0.66 |
| Sand/gravel (SB2) | 0.64 | 0.67 |
| Sand/textile (STB1) | 0.60 | 0.61 |
| Sand/textile (STB2) | 0.53 | 0.65 |

In this test, textile media for pretreatment was compared to layers of coarse sand and pea gravel. COD and BOD₅ removal and filter clogging were evaluated. Results from this test show that both sand/gravel and sand/textile bioreactors have excellent treatment capability for the removal of organic matter that was measured as BOD₅ and COD. The effluent obtained from these bioreactors was of high quality in terms of organic matter removal. Sand/textile bioreactors will be a better option where access to the site is difficult because textile leaves are lighter and can be transported easily. Should the need arise, replacing the textile leaf layer will be easier as compared to replacing a layer of a sand/gravel bioreactor.

The presence of visible turkey fat in the wastewater did not cause problems in bioreactor column operation as demonstrated from the high steady removal of organic loading and the lack of clogging. Cleaning, back washing, raking, or replacing of top gravel or textile layers was not necessary to maintain bioreactor column operation. The data obtained from this test indicate that sand bioreactors having a textile leaf treatment layer can be effectively used for the treatment of high strength wastewater and the treated wastewater can achieve BOD₅ values to meet strict effluent discharge limits.

1-35. (canceled)

36. A bed for treating wastewater, said bed comprising:
a drain header;
a plurality of drain conduits in fluid communication with said drain header;
a supply header positioned above said drain header;
a plurality of branch conduits in fluid communication with said supply header and positioned above said drain header;
a plurality of riser conduits, each one of said riser conduits extending from a respective one of said branch conduits;
a plurality of manifolds positioned above said branch lines, each one of said manifolds being in fluid communication with a respective one of said riser conduits;
a plurality of distribution conduits positioned above said branch lines, at least two of said distribution conduits being in fluid communication with each of said manifolds, said distribution conduits for discharging said wastewater therefrom;
a layer of first granular material positioned between said drain conduits and said distribution conduits; and
a layer of treatment material positioned between said layer of first granular material and said distribution conduits.

37. The bed according to claim 36, further comprising a plurality of valves, each said valve being positioned between one of said riser conduits and one of said manifolds for controlling flow of said wastewater between said riser conduits and said manifolds.

38. The bed according to claim 37, wherein said valves are remotely controllable valves.

39. The bed according to claim 38, wherein said valves are solenoid valves.

40. The bed according to claim 37, further comprising a plurality of indexing valves, each said indexing valve being positioned between one of said valves and one of said manifolds for directing flow of said wastewater into said manifolds.

41. The bed according to claim 36, wherein said first granular material comprises fine sand.

42. The bed according to claim 36, wherein said treatment material comprises pea gravel.

43. The bed according to claim 36, wherein said treatment material comprises a plurality to textile leaves.

44. The bed according to claim 43, wherein said textile leaves are arranged randomly atop one another.

45. The bed according to claim 43, wherein said textile leaves have a rectangular shape.

46. The bed according to claim 43, wherein said textile leaves comprise a woven material.

47. The bed according to claim 43, wherein said textile leaves comprise a non-woven material.

48. The bed according to claim 43, wherein said textile leaves comprise felt.

49. The bed according to claim 48, wherein said felt is selected from the group consisting of polyester, polypropylene, nylon and combinations thereof.

50. The bed according to claim 36, further comprising a waterproof liner positioned beneath said drain conduits.

51. The bed according to claim 50, further comprising a layer of sand positioned beneath said waterproof liner.

52. The bed according to claim 36, further comprising a layer of second granular material positioned between said layer of first granular material and said drain conduits.

53. The bed according to claim 52, wherein said layer of second granular material comprises wash rock.

54. The bed according to claim 52, further comprising a layer of third granular material positioned between said layer of second granular material and said layer of first granular material.

55. The bed according to claim 54, wherein said layer of third granular material comprises pea gravel.

56. The bed according to claim 54, further comprising a layer of fourth granular material positioned between said treatment layer and said layer of first granular material.

57. The bed according to claim 56, wherein said layer of fourth granular material comprises coarse sand.

58. The bed according to claim 56, further comprising a fifth granular material positioned between said manifolds and said layer of treatment material.

59. The bed according to claim 58, wherein said fifth granular material comprises pea gravel.

60. The bed according to claim 36, wherein said distribution conduits have a plurality of holes therein for discharge of said wastewater.

61. The bed according to claim 60, wherein said holes are spaced apart from one another at intervals of about 1 foot.

62. The bed according to claim 36, wherein said drain conduits have a plurality of slots therein, said slots for admitting wastewater to said drain conduits for removal from said bed.

63. The bed according to claim 36, further comprising a storage tank for holding said wastewater.

64. The bed according to claim 63, further comprising a pump in fluid communication with said storage tank and said supply header for pumping said wastewater from said tank to said supply header.

65. The bed according to claim 36, further comprising a pump in fluid communication with said drain header, said pump for pumping said wastewater from said drain header and out of said bed.

66. The bed according to claim 36, wherein said bed is located within an excavation site.

67. A facility for wastewater treatment comprising a plurality of beds according to claim 36, said facility further comprising:
a storage tank for holding said wastewater;
a first piping network providing fluid communication between said storage tank and said supply header of each of said beds;
a second piping network providing fluid communication between said drain header of each of said beds.

68. The facility according to claim 67, further comprising a first pump positioned between said storage tank and said first piping network for pumping said wastewater from said storage tank into said supply headers of each of said beds.

69. The facility according to claim 67, further comprising a second pump in fluid communication with said second piping network for pumping said wastewater from said drain headers of each of said beds.

70. A method of operating the facility according to claim 67, the method comprising:
flowing a predetermined amount of said wastewater to only a first one of said beds;
stop flowing said wastewater to said first one of said beds;
flowing a predetermined amount of said wastewater to only a second one of said beds;
stop flowing a predetermined amount of said waste water to said second one of said beds.

71. A method of operating the facility according to claim 67, the method comprising:
flowing a predetermined amount of said wastewater to each one of said beds in turn, one after another, for all of said plurality of beds.
